(19) United States
(12) Patent Application Publication
(10) Pub. No.: US 2015/0059231 A1
(43) Pub. Date: Mar. 5, 2015

(54) Universal Flotation Device

(71) Applicant: Eric Williams, Kansas City, MO (US)

(72) Inventor: Eric Williams, Kansas City, MO (US)

(21) Appl. No.: 14/474,127

(22) Filed: Aug. 30, 2014

Related U.S. Application Data
(60) Provisional application No. 61/873,367, filed on Sep. 4, 2013.

(51) Int. Cl. A01K 87/00; A01K 97/00

(52) U.S. Cl. CPC A01K 87/007; A01K 97/00
USPC 43/21.2

(57) ABSTRACT

A flotation device defining a narrow middle section, comprising a buoyant core and a shiftable fastening element, and operable to achieve a plurality of engaging configurations, so as to be coupled to a plurality of objects of differing dimension and/or shape, including fishing rods at or near their center of gravity, and assemblies composed therewith.

### RELATED APPLICATIONS

This patent application claims priority to, and benefit from U.S. Provisional Patent Application Ser. No. 61/873,367, entitled “UNIVERSAL FLOTATION DEVICE,” filed on Sep. 4, 2013, the entirety of which is hereby incorporated by reference.

### BACKGROUND OF THE INVENTION

1. Field of the Invention

The present invention relates to flotation devices, and more particularly to a flotation device adapted for use with a plurality of potentially water-borne objects, such as fishing rods.

2. Description of the Prior Art

Losing his or her fishing rod remains the fisherman's second greatest scourge, just behind letting the big one get away. Flotation devices particularly adapted for use with fishing rods and reels (collectively referred to herein as “fishing rod”), whether for casting, spinning, or fly fishing, have long been developed to prevent such occurrences, and more particularly, to prevent the rod and reel from being submerged and/or facilitating its recovery. Among the prior art, includes a number of patents, such as for example, U.S. Pat. No. 5,592,773 issued to Perry, U.S. Pat. No. D327,726 issued to Lowrance et al., and U.S. Pat. No. 4,583,314, issued to Kirkland. While functional for their intended purposes, prior art measures have received minimal market penetration due to inherent shortcomings For example, prior art flotation devices do not engage the fishing rod at its center of gravity, resulting in the reel and handle remaining submerged while in use. Moreover, prior art measures typically present one-size-fits-all configurations that offer minimal flexibility (e.g., are only configured to engage fishing rods, and able to engage the rod at the butt section). Finally, conventional measures often present complex and intricate mounting instructions, that require manual dexterity to apply. As a result accidental loss of objects, including fishing gear, such as fishing rods, remain a major concern during activities proximate a body of water.

As such, there remains the need for a novel and improved floatation device that can be quickly and securely attached to a fishing rod at its center of gravity without hindering use, and is flexible in the degree and manner of its application.

### SUMMARY OF THE INVENTION

In view of the foregoing disadvantages inherent in the known types of fishing flotation devices now present in the prior art, the present invention provides a novel fishing flotation device that can be utilized to prevent the loss of fishing rods and other objects which are accidentally dropped into the water. The invention is useful for offering a flotation device configured to engage a fishing rod at its center of gravity, so as to result in horizontal retention within the water, while maintaining proper function of the handle, reel, and hook keeper. By causing the rod to achieve a horizontal orientation, retrieval is facilitated, and damage from prolonged submerging of intricate parts, such as metal reels, spools, guides, and/or handle is reduced. By engaging the rod at the reel and spool, and away from the flexible shaft, the invention is useful for offering a flotation solution that does not change the operation and feel of the shaft during fishing. The invention offers a facilely applied, removed, and therefore transferable solution, that may be used to engage and disengage a variety of objects interchangeably. Finally, by offering variable engagement options, the present invention is useful for offering a flotation device that is applicable to objects of differing dimension and shape. For example, in a doubled-over configuration, the invention may be used singularly to support the waist and lower torso of a human, or as a pair to effect a more flexible and functional life vest.

As such, the general purpose of the present invention, which will be described subsequently in greater detail, is to provide a novel and improved fishing float assembly and method which has many of the advantages of the fishing rod flotation devices mentioned heretofore and many additional novel features that result in a fishing flotation device which is not anticipated, rendered obvious, suggested, or even implied by any of the prior art fishing rod flotation devices, either alone or in any combination thereof.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is an object of the present invention to provide a novel flotation device that may be facilely and efficiently manufactured and marketed. It is a further object of the present invention to provide a flotation device that is of durable and reliable construction. An even further object of the present invention is to provide a novel rod flotation device which is susceptible of a low cost of manufacture with regard to both materials and labor, and which accordingly is then susceptible of low prices of sale to the consuming public, thereby making such flotation device economically available to the buying public. Yet another object of the present invention is to provide a novel flotation device that provides in the apparatuses and methods of the prior art some of the advantages thereof, while simultaneously overcoming some of the disadvantages normally associated therewith. Still another object of the present invention is to provide a novel and improved fishing rod flotation device which facilitates the use of such devices on a multitude of objects through the use of a resilient polystyrene foam which can be easily and securely fastened to such rods. Finally, another object of the present invention is to provide a novel and improved flotation device that is designed to prevent abrasive contact with fishing line associated with a fishing rod.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings of exemplary scale, wherein:

FIG. 1 is a perspective view of the universal flotation device, in accordance with a preferred embodiment of the invention;

FIG. 2 is an elevation of the device shown in FIG. 1 applied to a fishing rod at its center of gravity, wherein the rod is caused to float horizontally at the water's surface;

FIG. 3 is a plan view of the device shown in FIGS. 1-2, particularly illustrating first and second cross members, an interconnecting vertical member, and first and second straps engaged with the cross members, such that the device is in a first configuration for use;

FIG. 3a is a cross-section of the device taken along the line A-A, shown in FIG. 3, wherein the device is formed of a buoyant inner material, and outer casing, in accordance with a preferred embodiment of the invention;

FIG. 3b is a cross-section of the flotation device, wherein the device if formed of at least one inner bladder, air contained therein, and an outer casing, in accordance with a preferred embodiment of the invention;

FIG. 3c is a side elevation of the device shown in FIG. 3;

FIG. 4 is a plan view of the device shown in FIGS. 1-3 showing a doubled-over configuration, wherein the vertical member has been bent such that the cross-members are opposite, and the straps have been interconnected so as to define a receiving receptacle, in accordance with a preferred embodiment of the invention;

FIG. 5 is a plan view of the flotation device in a second configuration for use, wherein the straps have been interconnected and caused to engage the vertical member, in accordance with a preferred embodiment of the invention;

FIG. 6 is a perspective view of the flotation device in the first configuration of use coupled to a bucket handle;

FIG. 7 is a perspective view of the flotation device in the second configuration of use coupled to a cylinder disposed in water;

FIG. 8 is an elevation of the flotation device in a third configuration of use, wherein the straps are caused to form loops and coupled to swim shorts, so as to aid with buoyancy while swimming; and

FIG. 9 is an elevation of a flexible life vest comprising dual flotation devices presented in doubled-over configurations and interconnected, being donned by a human user.

### DESCRIPTION OF PREFERRED EMBODIMENTS

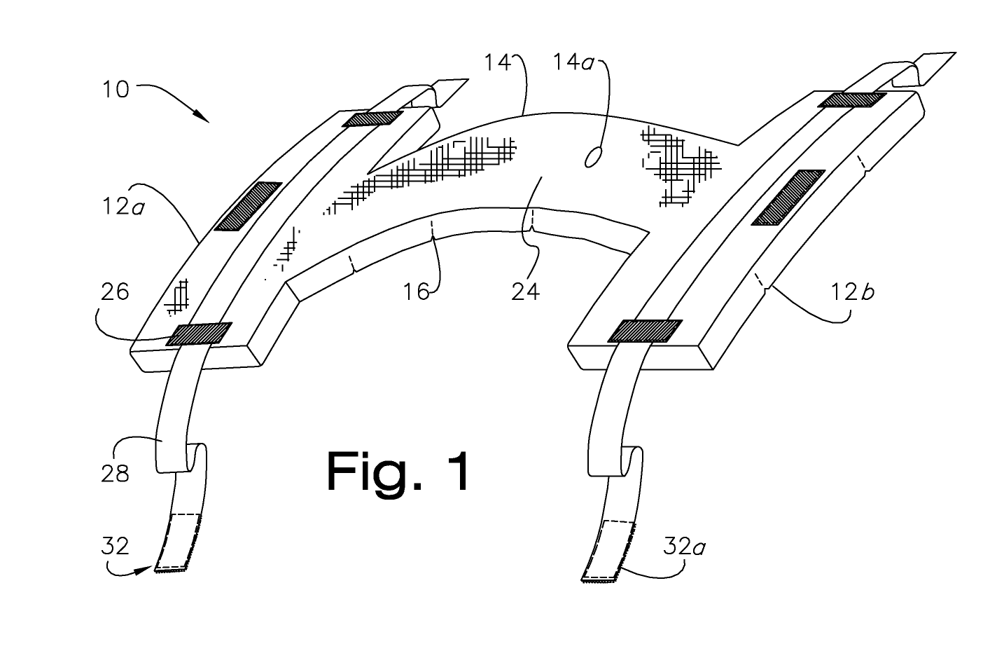

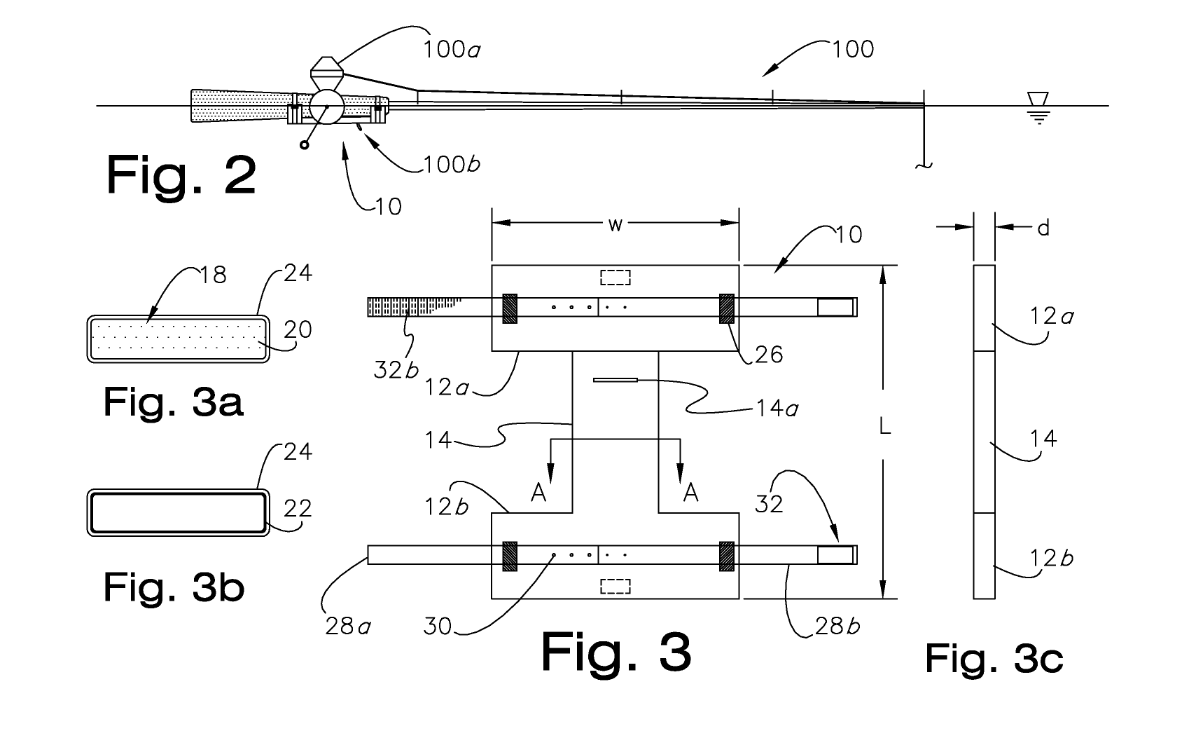

The following description of the preferred embodiments is merely exemplary in nature and is in no way intended to limit the invention, its application, or uses. With reference now to FIGS. 1-9, a novel flotation device embodying the principles and concepts of the present invention and generally designated by the reference numeral 10 will be described. As shown in FIG. 2, the flotation device 10 is particularly suited for use with a fishing rod 100, and more particularly, for engaging the reel 100a, spool, and handle of the rod 100. That is to say, the inventive device 10 is primarily useful for protecting fishing rods 100 of various types (e.g., rods of extra fast, fast, medium, or slow action type, rods having an open-face, close face, or bay casting reel; spinning or fly casting rods, etc.), by causing them to float horizontally at the water's surface. The geometric configuration and adjustability of the device 10 enable it to be preferably coupled beneath the reel 100a, which is at or near the center of gravity of most rods, while not hindering functionality and enjoyment. Together, it is appreciated that the flotation device 10 and fishing rod presents an inventive assembly that may be integrally constructed.

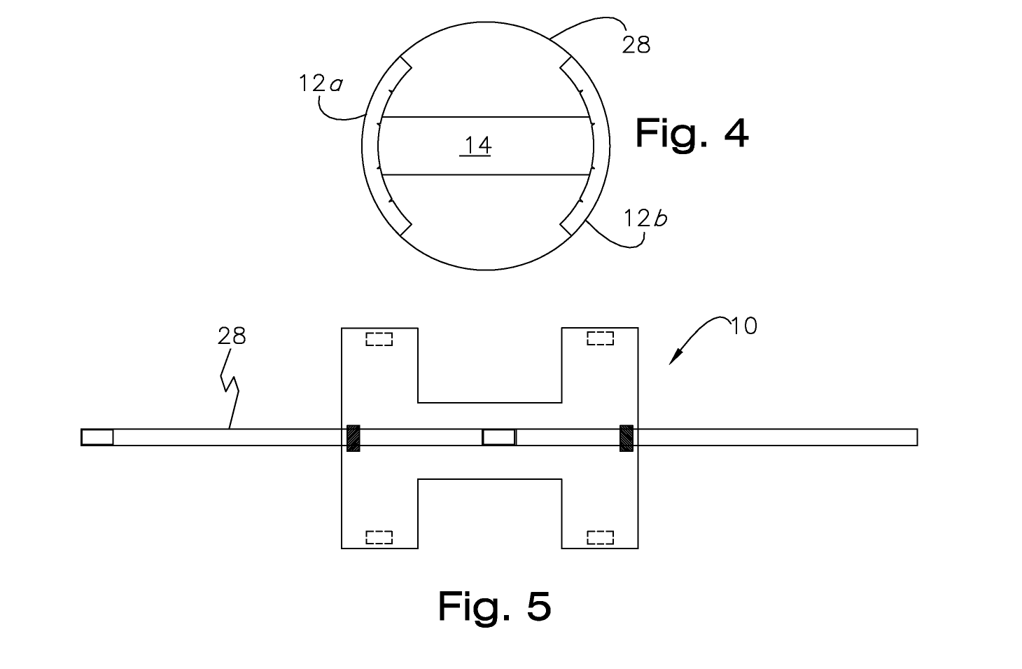

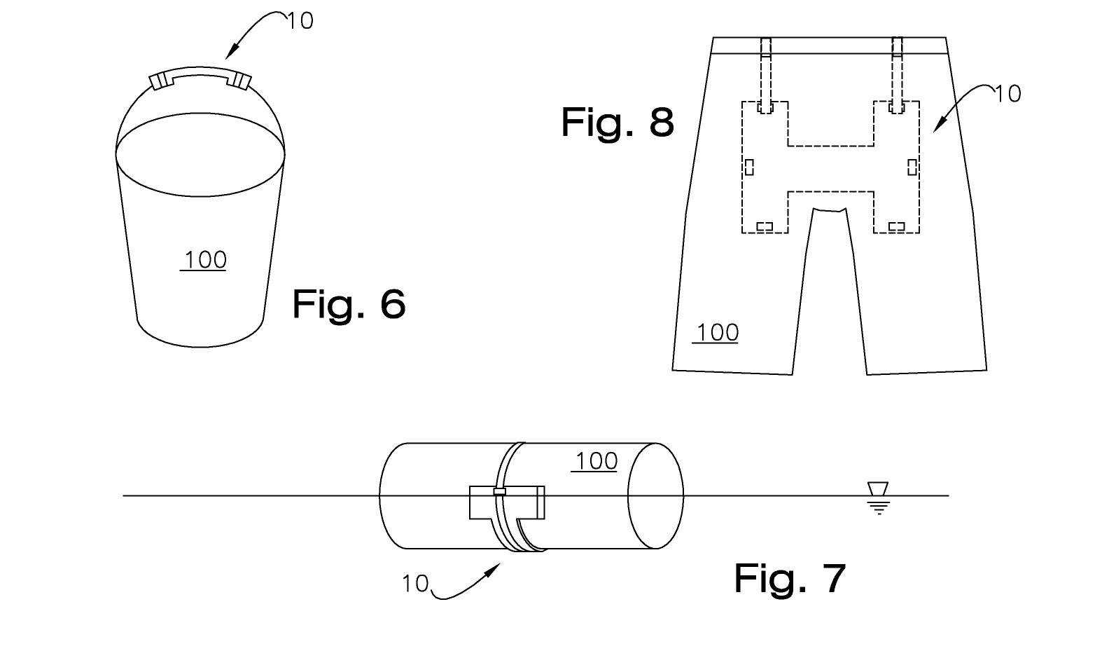

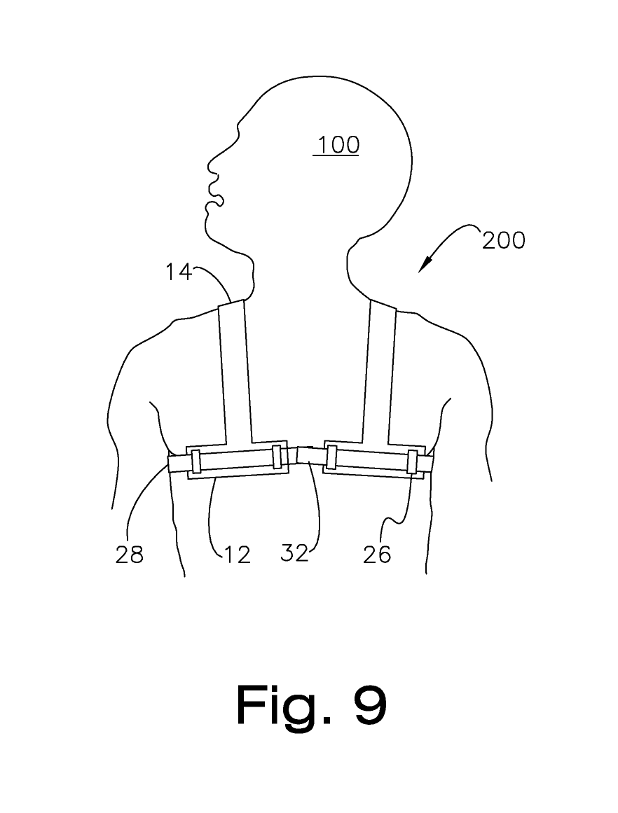

As further illustrated, however, application to a variety of objects 100 and suitability for use in varying applications and settings (e.g., fishing, swimming pools, etc.) will be readily appreciated. For example, in addition to fishing rods (FIG. 2), the “universal” flotation device may used to protect nets, bait buckets or tackle boxes as shown in FIG. 6, supply canisters as shown in FIG. 7, and other objects 100 prone to accidentally being submerged. It is appreciated that the device 10 may be used to intentionally retain the object 100 at or near the surface, and allow easy retrieval, for example, of a perforated fish storage container/cage. As shown in FIGS. 8 and 9, the device 10 may be donned (inconspicuously) by beginning to intermediate level swimmers seeking an aid in buoyancy. In this setting, the device 10 may be coupled to any string, loops, or belt comprising the user's swimming shorts 100 or bathing suit; and in other configurations, may be used to directly engage the swimmer 100. For example, in the singular doubled over configuration (FIG. 4) the device may be used to engage the lower torso and waist of a user (e.g., an infant) 100; and in a dual assembly may form a flexible life vest (FIG. 9) that aids a swimmer 100.

To effect functionality, the device 10 generally presents a body having major and minor opposite and congruent surfaces (wherein each surface is not necessarily planar), so as to present a maximum width, w, not less than twice, more preferably, not less than thrice, and most preferably, not less than six times the minimum depth, d, compare FIGS. 3 and 3c. Along the major surfaces, the device 10 defines a narrow middle section and wider end sections, whereas the preferred middle section is laterally and longitudinally centered. The device 10 is flexible, so as to be bendable along the major surfaces (FIGS. 1, 4, 6, and 7).

In the illustrated embodiment, the flotation device 10 presents first and second rectangular cross-members 12a,b and a vertical rectangular member 14 interconnecting and bifurcating the cross-members 12a,b, so as to form an I-shaped configuration (FIGS. 1, 3, and 5). The members 12a,b,14 present an overall length, l (FIG. 3); and the device 10 presents a width to length ration (i.e., w/l) not less than 0.25, more preferably, within the range 0.33 and 1.00, and most preferably, within the range of 0.65 to 0.75. For example, where particularly suited for use with a fishing rod 100, the length may be approximately 18 cm (i.e., 7 inches), and the width approximately 13 cm (i.e., 5 inches). The members 12a,b,14 may present any suitable cross-sectional configuration, but more preferably present a thin rectangular section (FIGS. 3a,b). Together the cross and vertical members 12a,b,14 preferably form an “I-shaped” configuration, as best shown in FIGS. 1, 3, and 5. The members 12a,b,14 may be integrally formed or formed by separate bodies and attached together; each individual member may also be formed of subparts, for example, to facilitate adjustability. In FIG. 1, separation lines 16 are indicated to reflect separate segments in a composite configuration, or fold lines, in an integral embodiment. The members 12a,b,14 are illustrated to exemplary scale; however, it is appreciated that the cross and/or vertical members 12a,b,14 may be modified in length and/or width to varying degrees as is necessary for application.

The device 10 includes a buoyant central core 18. In a preferred embodiment, the core 18 is formed of a dense polystyrene foam 20 material which is both lightweight and durable, and which is a material having a high buoyancy factor whereby it operates as a good flotation material. Alternatively, the core 18 may comprise of at least one inflatable bladder 22 having air (or other gas) disposed therein. In this configuration, it is appreciated that an air inlet (not shown) is provided to enable manual inflation and deflation. The core 18 may be thicker along the cross members or vertical member 12a,b,14 (FIG. 7). Finally, the preferred core 18 is adjustable. For example, a plurality of individual segments comprising the core 18 may be separately inflated and deflated as needed; or configured to receive differing numbers or sizes of foam material 20. The core 18 is preferably overlaid by a more durable cover 24. The cover 24 may be formed of a thin canvas, vinyl, fabric, rubber, plastic, or equivalent material, and is preferably water repellant. In a preferred embodiment, the cover 24 is formed of a canvas or fabric material presenting a camouflage pattern operable to facilitate outdoor activity. Alternatively, the cover 24 may be fluorescent, so as to facilitate retrieval of the engaged object 100 at night.

In a preferred embodiment, the vertical member 14 defines a through-hole 14a that facilitates use with fishing rods having hook keepers 100b. That is to say, the preferred vertical member 14 defines through-hole 14a large enough to allow the hook keeper 100b of the fishing rod 100 to pass through the device 10, when engaged beneath the reel 100a. Where a cover 24 overlays the core 18, it is appreciated that the through-hole 14a may be sealed, for example, through adhesive, by sewing, etc., so as to prevent water from entering the core 18. The through-hole 14a may define a cut out section, or be formed by cutting a slit through the member 14.

The device 10 further includes a fastening element for fixedly coupling the core 18 to the object 100 sought to be protected. In the illustrated embodiment, a series of stirrups 26 (i.e., holes, eyelets, sleeves, etc.) are shown in FIGS. 1, 3, and 5, as being attached to the outer surface of the cover 24 (or core 18, where no cover is provided); alternatively, a stirrup 26 may be formed by cutting a pair of laterally spaced slits in the cover 24. A first set of the stirrups 26 are positioned at the ends of the cross members 12a,b and oriented parallel to the vertical member; and a second set of the stirrups 26 are positioned at or near the ends of the vertical member 14 and oriented parallel to the cross members 12a,b (FIG. 3). The stirrups 26 may be sewed into a fabric cover (FIG. 1), or glued to a plastic exterior, etc. The stirrups 26 are configured to receive first and second straps 28 individually across the cross members 12a,b (FIGS. 1, and 3), and where connected across the vertical member 14. As used herein, it is appreciated that the term “straps” is non-limiting, and include other equivalent tensile elements, such as rope, chains, braids, cables, string, etc. The straps 28 are preferably adjustable in length, and elastic, so as to apply a compressive holding force to the protected object 100. With respect to adjustment, exemplary straps 28 may comprise of first second segments 28a,b that are snapped together along their shared axis, whereas a plurality of snaps 30 provides the adjustability in overall length (FIG. 3). To effect functionality, the fastening element is shiftable so as to effect a plurality of engaging configurations. In the illustrated embodiment, this is accomplished by shifting the set of stirrups 26 that the straps 28 are entrained within.

The attachment element 32 is illustrated as being of the hook and loop fastener type, commonly sold under the brand Velcro™; however, it is certainly within the ambit of the invention to employ any equivalent fastener, such as clips, snaps, latches, etc. The pad of male hooks 32a (FIG. 1) is disposed on one surface of a strap 28, and a bed of female loops 32b preferably overlays the entire opposite surface, such that the attachment point may be adjusted along the entire strap length. In this configuration, at least a minimum overlap length is provided depending upon the hold force required.

It is appreciated that the straps 28 and cross-members 12a,b may be integrally presented. That is to say, where dimensions allow, the straps 28 may be presented by the cross-members 12a,b, for example, by attaching the hook and loop fasteners 32a,b to opposite sides and surfaces thereof. Alternatively, the straps 28 may take the place of the cross-members 12a,b in the I-shape, such that the buoyant material is presented by the vertical member 14; in this configuration, the straps 28 may themselves be formed of buoyant material as well.

Thus, the device 10 may be used in a first configuration (i.e., width wise), wherein the straps 28 engage the cross members 12a,b (FIG. 3), a second configuration (i.e., length wise), wherein interconnected straps 28 circle and engage the vertical member 14 (FIG. 5), a third doubled-over configuration (FIG. 4), or a fourth double loops configuration (FIG. 8). In FIG. 4, the receptacle or doubled-over configuration is shown wherein the vertical member 14 has been bent such that the cross-members 12a,b are opposite, and the straps 28 have been interconnected so as to define a continuous wall. Depending upon the attachment points and overlap between the straps 28, the diameter of the receptacle can be adjusted to receive for example, the legs and lower torso of an infant similar to a diaper, or a snack bowl at a pool party, etc. It is appreciated that stability is better provided where the water surface is caused to rest across the horizontal cross-members 12a,b; and that as such, ideally supportable weights may be prescribed for different flotation devices 10. It is also appreciated that in larger scale or sizes, the receptacle may similarly be used by larger children, and adults, as an improved flotation aid that does not encumber leg motion while treading water or swimming.

In another swimming application, and as shown in FIG. 9, an inventive assembly 200 offered herein comprises first and second I-shaped flotation devices 10 joined laterally in doubled-over configurations. In this configuration, the assembly 200 may be used as a flotation aid for swimmers, and donned similar to a life vest. The vertical members 14 pass over the collar bone and down the shoulder blades, and the cross-members 12a,b preferably rest below the pectoral muscles, when the assembly is donned. At least one strap 28 encircles the user's chest and back across the four cross-members 12a,b and is fastened at an end to form a continuous wall. More preferably, two, three, or all four of the straps 28 may be interconnected as previously discussed to provide greater adjustability. The preferred straps 28 are elastic, so as to apply a light compressive force that does not inhibit expansion of the diaphragm, while holding the assembly 200 in place. The straps 28 may present a wider gap between adjacent cross-members in the back than in the front, when donned, so as to better fit an adult male torso (FIG. 9), or a more narrow gap in the back than in the front to better accommodate the breasts of an adult female.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Also, as used herein, the terms “first”, “second”, and the like do not denote any order or importance, but rather are used to distinguish one element from another, and the terms “the”, “a”, and “an” do not denote a limitation of quantity, but rather denote the presence of at least one of the referenced item. All ranges directed to the same quantity of a given component or measurement is inclusive of the endpoints and independently combinable.

What is claimed is:

1. A flotation device adapted for use with a plurality of objects presenting differing dimensions and/or shapes, said device comprising:
a body defining major and minor opposite and congruent surfaces, a minimum minor surface depth, a maximum major surface width not less than twice the minimum depth, and a narrow middle section along the major surface, wherein the body is flexible, so as to be bendable along the major surfaces, and includes a buoyant core, so as to cause each of the objects to float in water when engaged thereto; and
a fastening element operable to enable selective engagement between the body and one of said objects, and shiftable between a plurality of engaging configurations, so as to enable selective engagement between the body and a second of said objects.

2. The device as claimed in claim 1, wherein the width is not less than thrice the depth.

3. The device as claimed in claim 1, wherein the body presents a constant depth.

4. The device as claimed in claim 1, wherein the body includes first and second cross-members and a vertical member interconnecting the cross-members, so as to define an I-shape along the major surfaces.

5. The device as claimed in claim 4, wherein the cross-members define a device width, the vertical member produces a device length, and the width to length ratio is within the range 0.33 to 1.00.

6. The device as claimed in claim 4, wherein the vertical member defines a through-hole.

7. The device as claimed in claim 1, wherein the fastening element includes first and second sets of stirrups, and first and second straps, and the first and second straps are shiftable between, so as to be selectively entrained by, the first and second sets of stirrups.

8. The device as claimed in claim 7, wherein the straps are adjustable in length.

9. The device as claimed in claim 1, wherein the core is presented by a polystyrene foam material.

10. The device as claimed in claim 1, wherein the core is presented by an inflatable bladder.

11. The device as claimed in claim 1, wherein the body further includes a cover overlaying the core.

12. The device as claimed in claim 1, wherein the body is integral, and defines fold lines.

13. The device as claimed in claim 1, wherein the body is a composite of separate segments.

14. The device as claimed in claim 1, wherein the core is modifiable so as to vary the buoyancy.

15. The device as claimed in claim 1, wherein the narrow middle section is longitudinally and laterally centered.

16. An assembly comprising:
a fishing rod including a handle, reel, and shaft, and defining a center of gravity at or near the reel; and
a flotation device spaced from the shaft and attached to the handle adjacent the reel,
said device including a buoyant core, and being configured to cause the rod to float horizontally in water.

17. The assembly as claimed in claim 16, wherein the rod further includes a hook keeper, and the device defines a through-hole configured to receive the hook keeper, when the device is attached to the handle adjacent the reel.

18. The assembly as claimed in claim 16, wherein the handle and device are integrally presented.

19. An assembly comprising:
first and second laterally adjacent I-shaped flotation devices, each including first and second cross-members and a vertical member interconnecting the cross-members, wherein the devices are bent along the vertical members, so as to form doubled-over configuration and present front and back pairs of cross-members; and
a fastening element attached to the cross-members and interconnecting the devices, so as to form a continuous wall and define a first spacing between the front pair of cross-members, and a second spacing between the back pair of cross-members.

20. The assembly as claimed in claim 19, wherein the fastening element is adjustable, so as to modify the first and/or second spacing.
